(19) United States
(12) Patent Application Publication
(10) Pub. No.: US 2008/0159434 A1
(43) Pub. Date: Jul. 3, 2008

(54) Method of efficient techniques in an orthogonal frequency division multiplexing system with channel evaluation

(75) Inventors: Seog-Hong Park, Seoul (KR); So-Young Yeo, Seongnam-si (KR); Dong-Hyun Park, Seoul (KR); Hyoung-Kyu Song, Seongnam-si (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: MewTel Technology Inc., Seoul (KR)

(21) Appl. No.: 11/646,818

(22) Filed: Dec. 28, 2006

(51) Int. Cl. H04L 27/04

(52) U.S. Cl. 375/296

(57) ABSTRACT

A method of adaptive modulation in an OFDM system with channel evaluation with two types of adaptive transmission schemes that include several modulation schemes to achieve efficient transmission service. By evaluating channel environment, the methods select the proper modulation scheme among the BPSK, QPSK, 16QAM, and 64QAM. Therefore, the methods either increase the performance or reduce the signaling overhead. By using the method, the reliable and efficient transmission services are achieved.

### FIELD OF THE INVENTION

The present invention relates to a method of adaptive modulation (AM) in an OFDM (orthogonal frequency division multiplexing) system. More particularly, the present invention relates a method of selecting the modulation scheme among the BPSK (binary phase shift keying), QPSK (quadruple phase shift keying), 16QAM (16-quadrature amplitude modulation), and 64QAM (64-quadrature amplitude modulation) according to the channel condition. Also, to reduce the signal overhead, banded adaptive modulation scheme is compared the conventional adaptive modulation scheme. By properly selecting the modulation scheme, the two schemes of adaptive methods have the improved system performance in an OFDM system.

### BACKGROUND OF THE INVENTION

With increasing of user demands for multimedia and various data services, the high-rate transmission is required in orthogonal frequency division multiplexing (OFDM) system. In conventional systems, a fixed modulation technique does not adapt to fading condition and requires a fixed link margin to maintain acceptable performance when the channel condition is inferior.

Adaptive modulation is a well known powerful method for improving the system performance, and adaptive OFDM (A-OFDM) has been studied. The goal of adaptive scheme in an OFDM system is to select an appropriate number of information bits and to choose the suitable adaptation mode for transmission in each subcarrier in order to improve the system performance. The key points determining the performance of adaptive scheme are the estimation of the channel condition and decision of the appropriate parameter for the next frame transmission. In order to provide high quality of transmission over frequency selective fading channels, the signal-to-noise ratio (SNR) estimator is employed as the standard measure of quality of analog signals in noise environment.

### SUMMARY OF THE PREFERRED EMBODIMENTS

The present invention has been made in an effort to improve the performance of fixed modulation schemes.

It is an object of the present invention to provide a method of adaptive modulation which guarantees the intelligent communication for various channel environments with some adaptive modulation techniques.

To achieve the object, the present invention uses above modulation schemes (BPSK, QPSK, 16QAM, and 64QAM). A schematic of this idea is depicted in FIG. 1.

And the various types of banded AM is executed and gauged.

In A-OFDM system, transmitter is required subcarrier-by-subcarrier adaptive modulation (subcarrier AM) information to the receiver for the correct demodulation and decoding. The information bits are transmitted through the side information channel and the number of required bits for adaptive scheme would be increased according to the number of subcarriers and available adaptive schemes. As the adaptive information bits increase, the overall capacity performance of system is decreased. Therefore, to overcome the signaling overhead, the present invention uses banded modulation scheme which applies the same modulation scheme over all subcarriers and returns only one type information through return channel. And a banded adaptive modulation (banded AM) technique is suggested and compared with the proposed subcarrier AM technique.

The modulation mode selector in FIG. 3 between BPSK, QPSK, 16QAM and 64QAM decides its modulation mode according to the channel SNR. A basic mode selection probability Pr(M) is defined as the probability of selecting the l-th mode from the set of available modulation modes. The modulation mode Mᵢ is defined by the following rules

Choose mode M when μᵢ≦ρ<μᵢ₊₁

where ρ and μₗ denote the immediate SNR value and the mode-switching threshold level, respectively.

And for banded AM, the common SNR value can be obtained as following rules

$${ρ}_{b} = \{ \begin{matrix}{min}_{i ∈ N} {ρ}_{i , b} \\ {avg}_{i ∈ N} {ρ}_{i , b} \\ {max}_{i ∈ N} {ρ}_{i , b}\end{matrix}$$

where ρ_{i,b} is SNR value of the i-th subcarrier in the b-th band, and ρ_{b} is common SNR value which is applied in the one band.

By properly selecting the modulation scheme, the two types of methods have the improved system performance.

### BRIEF DESCRIPTION OF THE DRAWINGS

Further objects and other advantages of the present invention will become apparent from the following description in conjunction with the attached drawings, in which:

FIG. 1 is a block diagram of an A-OFDM system.

FIG. 2 represents the properties of 3 types banded AM as the efficient ratio in a certain SNR value.

FIG. 3 is BER and BPS performances of method of subcarrier AM in OFDM system.

FIG. 4 is BER and BPS performances of methods of banded AM in OFDM system.

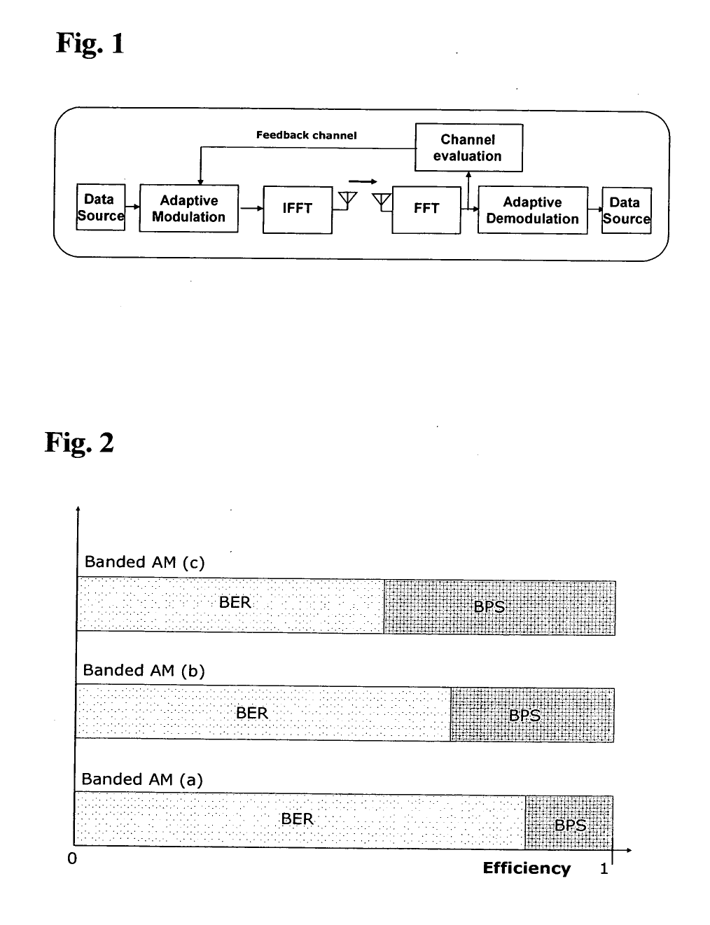

TABLE 1 is modulation rules based on the instantaneous SNR value.

### DETAILED DESCRIPTION OF THE PREFERRED EMBODIMENTS

Preferred embodiments of the present invention will now be described in detail with reference to the accompanying drawings.

In OFDM system, at the transmitter, the transmitted stream is broken into OFDM sequences denoted by S(k), k=0, . . . , K−1. Each OFDM symbols are modulated by means of the inverse fast Fourier transform (IFFT) on K subcarriers. At the receiver, the received signals are similarly broken into sequences and processed using a fast Fourier transform (FFT). Since the received signals are corrupted by noise, the output in the frequency domain is

Y(k)=H(k)S(k)+N(k), Equation 1]

where H(k) is the channel gain in the k-th subcarrier, and N(k) is additive white Gaussian noise (AWGN) whose elements are independent with unity variance, respectively.

The present invention selects the suitable modulation scheme according to channel environment. Therefore, the transmitter requires an estimate of the channel conditions for selection of the appropriate parameters for the next transmission. Thus, to estimate the channel condition, the comparison of corrupted and original preamble sequences is defined in the form of

ε(k)=Y(k)−H(k)S(k), [Equation 2]

where H(k)S(k) is used as reference for observed signal in the sub-band. The estimated SNR, which specify the power ratio of received pure signal and noise, is given by

$${ρ}_{k} [ dB ] = 10 {log}_{10} \frac{{\vert S ( k ) \vert}^{2} {\vert H ( k ) \vert}^{2}}{{ɛ ( k )}^{2}} . \qquad [ Equation 3 ]$$

The modulation mode is selected from the set of binary phase shift keying (BPSK), quadrature phase shift keying (QPSK), 16-quadrature amplitude modulation (16QAM), 64-quadrature amplitude modulation (64QAM), as well as “No Tx” according to the estimated SNR output. The modulation mode M is defined follows

Choose mode M when μᵢ≦ρ<μᵢ₊₁ [Equation 4]

where ρ and μₗ denote the immediate SNR value and the mode-switching threshold level, respectively. And mode selection probability P_{M} is defined as the probability of selecting the i-th mode from the set of available modulation modes,

$$\begin{matrix}{P}_{M} = Pr [ {μ}_{i} \leq ρ < {μ}_{i + 1} ] \\ = {\int }_{{μ}_{i}}^{{μ}_{i + 1}} f ( ρ ) d ρ \\ = {F}_{C} ( {μ}_{i + 1} ) - {F}_{C} ( {μ}_{i} )\end{matrix} \qquad [ Equation 5 ]$$

where ƒ(ρ) represents the probability density function (PDF) of ρ, and F_{C}(·) is the complementary cumulative distribution function (CDF).

The average throughput B expressed in terms of bits per sunbcarrier (BPS) can be described as

$$\begin{matrix}B = {\sum }_{k = 0}^{K - 1} {b}_{k} {\int }_{{μ}_{i}}^{{μ}_{i + 1}} f ( ρ ) d ρ \\ = {\sum }_{k = 0}^{K - 1} {b}_{k} {P}_{M}\end{matrix} \qquad [ Equation 6 ]$$

which can be formulated as the weighted sum of the throughput bₖ of the individual modes.

And, the present invention selects banded AM method which reduces the control signal bits maintaining the performance. With the channel information including estimated SNR, optimum modulation scheme is applied for all subcarriers in the same band using banded AM scheme. Assume that the K subcarriers are divided into b bands and each band includes N subcarriers. The N subcarriers are implemented using same modulation scheme that is decided by the evaluated ρ_{b} of the all subcarriers in one band. In other words, banded AM corresponds to the special case of applying the same modulation scheme for assigned subset of subcarriers. [Equation. 7] denotes the several equations for searching the common SNR value of a particular band

$${ρ}_{b} = \{ \begin{matrix}{min}_{i ∈ N} {ρ}_{i , b} & ( a ) \\ {avg}_{i ∈ N} {ρ}_{i , b} & ( b ) \\ {max}_{i ∈ N} {ρ}_{i , b} & ( c )\end{matrix} \qquad [ Equation 7 ]$$

where ρ_{i,b} is SNR value of the i-th subcarrier in the b-th band, and ρ_{b} is common SNR value which is applied in the one band. In case (a), since minimum SNR value is obtained and assigned in b-th band, it has the best BER performance than others, while the worst BPS performance is obtained among other schemes. To the contrary, the banded AM with case (c) has the best BPS performance in 3 types of banded AM. FIG. 2 briefly represents the properties of 3 types banded AM as the efficient ratio in a certain SNR value.

According to the property of banded AM, the same modulation mode is applied, so that the modulation information bit can be decreased. Consequently, by adjusting the number of bands and applying to the A-OFDM system, the overall signal overhead can be reduced.

Therefore, by properly selecting the modulation scheme, the two types of methods have the improved system performance.

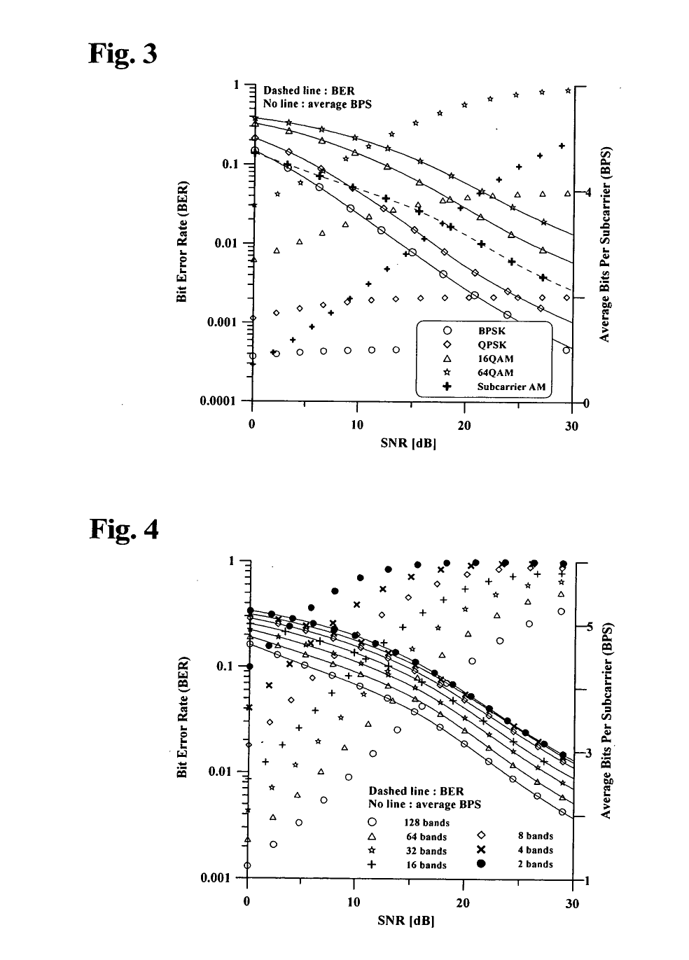

In FIG. 3, we show the BER and average BPS (bits per subcarrier) throughput performance of OFDM system with the methods of adaptive modulation. In this figure, performances of fixed rate BPSK, QPSK, 16QAM, and 64QAM which mean that all subcarriers are modulated by the fixed modulation scheme uncorrelated with channel condition are shown as reference. As shown in FIG. 3, BER performance of OFDM system with adaptive scheme can be remarkably improved as compared with OFDM system with fixed modulation (i.e., 64QAM scheme). It can be found that the adaptive schemes have generally better system performance than the others at low and high SNR. The BPS performances both proposed system and conventional system are also depicted. As illustrated in this figure, the improvement of average BPS can be achieved by employing AM to OFDM system. In other words, average BPS throughput of A-OFDM outperforms one of general systems without adaptive scheme.

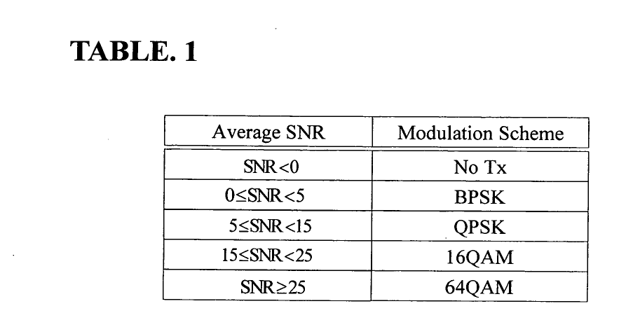

In the case of banded AM, the banded AM means that N consecutive subcarriers are banded and same modulation scheme is implemented at particular band. To adapt appropriately modulation mode in each band, common SNR value of N subcarriers can be obtained by several types of banded AM (i.e. (a), (b), and (c)). In FIG. 4, the BER and BPS performances of A-OFDM based on the case (c) are depicted. To measure the performance of banded AM, we adjust the number of bands and apply the banded AM to the A-OFDM system. As shown in this figure, BER performance of A-OFDM system with banded AM is improved according to the number of bands. However, BPS performance of banded AM scheme is increased as the number of bands is increased. Also, the signaling overhead of A-OFDM with the few number of bands can be reduced in expense of BER reduction. Therefore, to decide the number of bands can be significant point for the various channel condition.

While this invention has been described in connection with what is presently considered to be the most practical and preferred embodiment, it is to be understood that the invention is not limited to the disclosed embodiments, but, on the contrary, is intended to cover various modifications scope of the appended claims.

What is claimed is:

1-6. (canceled)

7. In a transmitter, a method of transmitting information data by using a decided modulation scheme according to received feedback information comprising a method of deciding a modulation mode using a method of estimating SNR where
$$ρ [ dB ] = 10 {log}_{10} \frac{{\vert H ( k ) \vert}^{2} {\vert {S}_{i} ( k ) \vert}^{2}}{{ɛ ( k )}^{2}}$$
$$and$$
$$ɛ ( k ) = Y ( k ) - H ( k ) S ( k ) .$$
